(19) United States
(12) Patent Application Publication
(10) Pub. No.: US 2003/0160821 A1
(43) Pub. Date: Aug. 28, 2003

(54) Graphic user interface modification method and recorded media thereof

(76) Inventor: Jeong-Kwan Yoon, Seongnam-city (KR)

Correspondence Address: Robert E. Bushnell, Suite 300, 1522 K Street, N.W., Washington, DC, 20005-1202, US

(21) Appl. No.: 10/359,713

(22) Filed: Feb. 7, 2003

(30) Foreign Application Priority Data
Feb. 26, 2002 (KR) 2002-10187

(51) Int. Cl. G09G 5/00

(52) U.S. Cl. 345/762

(57) ABSTRACT

A graphic user interface (GUI) modification method for changing the graphic user interface (GUI) of an application program, including the steps of storing property information of each component comprising the graphic user interface (GUI), and data for making a software program to display the graphic user interface (GUI) on a user monitor in real time by reading the property information of each component, separately, displaying corresponding property information among the stored property information to a display window, and updating property information by receiving a changed property value through the display window, and displaying changed graphic user interface (GUI), after receiving changed property information and operating the software program to display the graphic user interface (GUI). Therefore, a need to modify source code to change a property value can be eliminated because the property value can be changed easily.

### CLAIM OF PRIORITY

This application makes reference to, incorporates the same herein, and claims all benefits accruing under 35 U.S.C. §119 from my application GRAPHIC USER INTERFACE MODIFICATION METHOD AND RECORDED MEDIA THEREOF filed with the Korean Industrial Property Office on Feb. 26, 2002 and there duly assigned Serial No. 10187/2002.

### BACKGROUND OF THE INVENTION

1. Technical Field

The present invention relates to a graphic user interface (GUI) modification method and a recorded media thereof. More particularly, the present invention relates to a graphic user interface modification method and a recorded media thereof providing a program operator and developer with the capability to easily modify a display window by using a property window in real time.

2. Related Art

Generally, a display window is configured according to a view of a development company or a development person, because there is no standard in developing a graphic user interface (GUI).

A component of a screen configuration usually includes a property such as a font, a label, a position, a size, a color, or an edge. Because the graphic user interface (GUI) is much influenced by personnel trends, a user often requests to modify the graphic user interface (GUI). In this case, a system developer modifies, tests and redistributes the graphic user interface (GUI) according to the user's requests.

Therefore, there is a disadvantage that the system developer often modifies the graphic user interface (GUI) according to the user's trends, and that the user waits for the graphic user interface (GUI) until the system developer completes to modify the graphic user interface (GUI). Additionally, the above described modification will be repeated when the system developer does not satisfy the user's intentions fully. That arrangement can be inconvenient because a user and a system developer must perform tasks which would otherwise be unnecessary.

A contemporary method of modifying the graphic user interface (GUI) requires that the user and the system developer perform tasks that would otherwise be unnecessary. Moreover, when the graphic user interface (GUI) is unnecessarily mixed with pure display functions, it is more difficult to recycle developed source code.

Exemplars of recent efforts regarding graphic user interfaces are disclosed, for example, in U.S. Pat. No. 6,480,865 to Lee et al., entitled FACILITY FOR ADDING DYNAMISM TO AN EXTENSIBLE MARKUP LANGUAGE, issued on Nov. 12, 2002, U.S. Pat. No.6,429,882 to Abdelnur et al., entitled USER INTERFACE COMPONENT, issued on Aug. 6, 2002, U.S. Pat. No. 6,476,833 to Moshfeghi, entitled METHOD AND APPARATUS FOR CONTROLLING BROWSER FUNCTIONALITY IN THE CONTEXT OF AN APPLICATION, issued on Nov. 5, 2002, U.S. Pat. No. 6,480,207to Bates et al., entitled METHOD, APPARATUS AND COMPUTER PROGRAM PRODUCT FOR IMPLEMENTING GRAPHICAL USER INTERFACE (GUI) WINDOW CONTROL, issued on Nov. 12, 2002, and U.S. Pat. No. 6,429,885 to Saib et al., entitled GUI RESOURCE EDITOR FOR AN EMBEDDED SYSTEM, issued on Aug. 6, 2002. While these contemporary efforts contain merit, further improvements can also be contemplated.

### SUMMARY OF THE INVENTION

To overcome the above described problems, the present invention provides a graphic user interface (GUI) modification method, and recorded media thereof, for modifying the graphic user interface (GUI) in real time to reduce the effort required of a user and of a system developer regarding graphic user interface (GUI) modification, and for isolating the graphic user interface (GUI) from pure display functions in order to increase the recycling of developed source code.

The present invention provides a graphic user interface (GUI) modification method for changing the graphic user interface (GUI) of an application program, comprising the steps of: storing property information of each component comprising the graphic user interface (GUI), and data for making a software program to display the graphic user interface (GUI) on a user monitor in real time by reading the property information of each component, separately; displaying corresponding property information among the stored property information to a display window, and updating property information by receiving a changed property value through the display window; and displaying changed graphic user interface (GUI), after receiving changed property information and operating the software program to display the graphic user interface (GUI).

The step of storing property information uses a file with an Extensible Markup Language (XML) extension to store the property information. The file with an Extensible Markup Language (XML) extension stores a property parameter defined by a file with a Document Type Definition (DTD) extension, while the file with Document Type Definition (DTD) extension designates a kind of a component property corresponding to each display window.

The kind of a component property includes at least one of an identification, a type, an x-axis position, a y-axis position, a width, a height, an optimum size, a maximum size, a minimum size, a label, a font, a background, a foreground, an edge, a color.

The step of updating property information further comprises the steps of: interrupting an input event to a main panel of the graphic user interface (GUI) displayed to the present display window; overlapping a glass panel for selecting a component comprising the main panel to a main panel; displaying the property information of a component corresponding to a predetermined coordinate to an additional display window, in the case that the predetermined coordinate is selected on the glass panel; displaying the main panel of the graphic user interface (GUI) applying changed property information, in the case that the changed property information is inputted through the display window; and updating stored corresponding property information by the changed property information, in the case that a user re-confirms the displayed main panel.

The present invention provides a recorded media for recording a software program operating and changing graphic user interface (GUI) of an application program, comprising: a first storage module for storing property information of each component comprising a display window of the graphic user interface (GUI); a second storage module for storing data of the software program displaying the graphic user interface (GUI) to a user monitor in real time by reading property information of each component in real time; and a graphic user interface (GUI) management module for displaying property information stored in the first storage module to the display window, for updating property information of the first storage module by receiving a changed property value through the display window, and for displaying a changed display window according to the changed property information, when a user requests.

The graphic user interface (GUI) management module includes: a first function module for operating the software program by data stored in the second storage module, and for displaying a main panel of the graphic user interface (GUI) to the display window by reading property information stored in the first storage module; a second function module for interrupting an input event to the main panel of the graphic user interface (GUI) displayed in the present display window, and for overlapping a glass panel for selecting a component comprising the main panel to the main panel to receive a predetermined coordinate through the glass panel; a third function module for displaying an additional display window by reading property information of a component corresponding to the predetermined coordinate from the first storage module in the case that the predetermined coordinate is inputted to the glass panel generated by the second function module , and for receiving a changed property information through the display window; and a fourth function module for updating property information of the first storage module by the changed property information, to display the main panel of the graphic user interface (GUI) applying the changed property information, in the case that the changed property information is inputted through the display window generated by the third function module. The property information for each component in the first storage module is stored as a file with an Extensible Markup Language (XML) extension.

In accordance with the principles of the present invention, as embodied and broadly described, the present invention provides a graphic user interface (GUI) modification method for changing the graphic user interface of an application program, the method comprising: storing property information of a plurality of components of a graphic user interface, the plurality of components including at least a first component; storing data of a software program displaying the graphic user interface on a monitor in dependence upon the stored property information of the components; displaying at least a portion of the stored property information of the first component to a display window on the monitor; when receiving changed property information at the display window, updating the stored property information of the first component in dependence upon the changed property information; and when the stored property information is updated, operating the software program to display changed graphic user interface in dependence upon the changed property information.

In accordance with the principles of the present invention, as embodied and broadly described, the present invention provides a recorded media for recording a software program operating and changing a graphic user interface (GUI) of an application program, comprising: a first storage module storing property information of a plurality of components of a graphic user interface, the plurality of components including at least a first component; a second storage module storing data of a software program displaying the graphic user interface to a monitor by reading the stored property information from said first storage module; and a graphic user interface management module displaying at least a portion of the property information stored in said first storage module to a display window, updating the property information stored in said first storage module by receiving changed property information at the display window, and displaying a changed graphic user interface in dependence upon the received changed property information.

In accordance with the principles of the present invention, as embodied and broadly described, the present invention provides a computer-readable medium having a set of computer-executable instructions for performing a method, the set of instructions comprising one or more instructions for: storing property information of a plurality of components of a graphic user interface, the plurality of components including at least a first component; storing data of a software program displaying the graphic user interface on a monitor in dependence upon the stored property information of the components; displaying at least a portion of the stored property information of the first component to a display window on the monitor; when receiving changed property information at the display window, updating the stored property information of the first component in dependence upon the changed property information; and when the stored property information is updated, operating the software program to display changed graphic user interface in dependence upon the changed property information.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a software function block diagram for performing a graphic user interface (GUI) modification, in accordance with the principles of the present invention;

FIG. 2 illustrates an example of contents of files with an Extensible Markup Language (XML) extension to store property information of a component, in accordance with the principles of the present invention;

FIG. 3 illustrates an example of contents of files with a Document Type Definition (DTD) extension to store property information of a component, in accordance with the principles of the present invention;

FIG. 4 is a display window generated by a module such as NBJDragPanel, in accordance with the principles of the present invention;

FIG. 5 illustrates a property window generated by a module such as NXPropertyDialog, in accordance with the principles of the present invention;

FIG. 6 is a conceptual diagram illustrating connection relations among each function block of FIG. 1, in accordance with the principles of the present invention; and

FIG. 7 is a flow chart performing the graphic user interface (GUI) modification among each function block of FIG. 1, in accordance with the principles of the present invention.

### DESCRIPTION OF EMBODIMENTS FOR CARRYING OUT THE INVENTION

While the present invention will be described more fully hereinafter with reference to the accompanying drawings, in which details of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Illustrative embodiments of the invention are described below. In the interest of clarity, not all features of an actual implementation are described. In the following description, well-known functions, constructions, and configurations are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

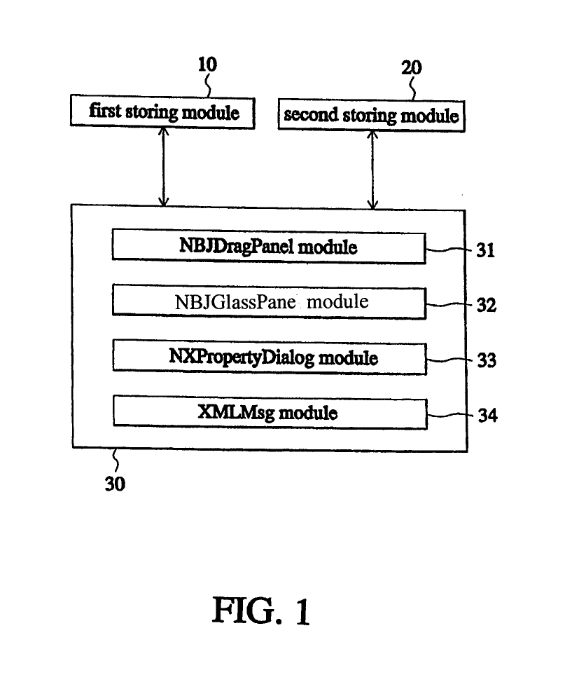

FIG. 1 is a software function block diagram for performing a graphic user interface (GUI) modification, in accordance with the principles of the present invention. Referring to FIG. 1, the graphic user interface (GUI) device comprises a first storage module 10, a second storage module 20, and a graphic user interface (GUI) management module 30. The first storage module 10 stores property information for each component comprising the graphic user interface (GUI).

A display program (not shown) reads property information of each component and displays the graphic user interface (GUI) in a user monitor (not shown) in real time. Here, the term “real time” indicates that the graphic user interface (GUI) is displayed within a small period of time after receiving stimuli, with the small period of time being generally measured in milliseconds or microseconds. A real time system typically must guarantee a response to an event within a predetermined amount of time.

The second storage module 20 stores the property information used by the display program. The graphic user interface (GUI) management module 30 displays property information stored in the first storage module 10 to the user monitor (not shown), when the user requests. In more, the graphic user interface (GUI) management module 30 updates property information of the first storage module 10 by receiving the changed property information through the user monitor, and displays the modified graphic user interface (GUI) according to the changed property information.

The first storage module 10 stores property information of each component comprising the graphic user interface (GUI) displayed on the user monitor. In storing the property information, a file having an Extensible Markup Language (XML) extension is preferred for the convenience of revision and exchange to the property information.

The second storage module 20 stores each property information read from the first storage module 10 and displays the graphic user interface (GUI) to the user monitor (not shown) when the display program runs. Therefore, even though property information stored in the first storage module 10 is changed, property information stored in the second storage module 20 is not changed.

The graphic user interface (GUI) management module 30 includes an NBJDragPanel module 31, an NBJGlassPane module 32, an NXPropertyDialog module 33, and an XMLMsg module 34. The NBJDragPane module 31 runs the display program (not shown) using data and property information stored in the second storage module 20. The display program reads property information stored in the first storage module 10 again and displays the main panel of the graphic user interface (GUI) to the user monitor (not shown). The NBJGlassPane module 32 interrupts input events for the main panel of the graphic user interface (GUI) displayed on the user monitor (not shown), and overlaps a glass panel for selecting components comprising the main panel to the main panel to receive a predetermined coordinate.

When a predetermined coordinate is inputted on the glass panel generated by the NBJGlassPane module 32, the NXPropertyDialog module 33 reads property information of a component corresponding to the predetermined coordinate from the first storage module 10, and displays the property information to an additional display window. In this case, the display window belongs to one of several graphic user interface (GUI) displayed in the user monitor. The NXPropertyDialog module 33 receives property information changed through the display window.

When changed property information is inputted through the display window generated by the NXPropertyDialog module 33, the XMLMsg module 34 upgrades the corresponding property information of the first storage module 10 to display the changed property information to the main panel of the graphic user interface (GUI).

Therefore, the present invention stores property information as a file having the Extensible Markup Language (XML) extension, reads property information of a component selected from the file having the Extensible Markup Language (XML) extension, and displays the selected property information to the display window. When a property value is changed through the display window, the property value of a selected component is changed and reflected to the graphic user interface (GUI) of the user monitor. In more, the changed property value of the component is stored as a file having an Extensible Markup Language (XML) extension.

The following statements will describe a file with the Extensible Markup Language (XML) extension for storing property information of a component and a file with a Document Type Definition (DTD) extension for defining the file with the Extensible Markup Language (XML) extension in more detail.

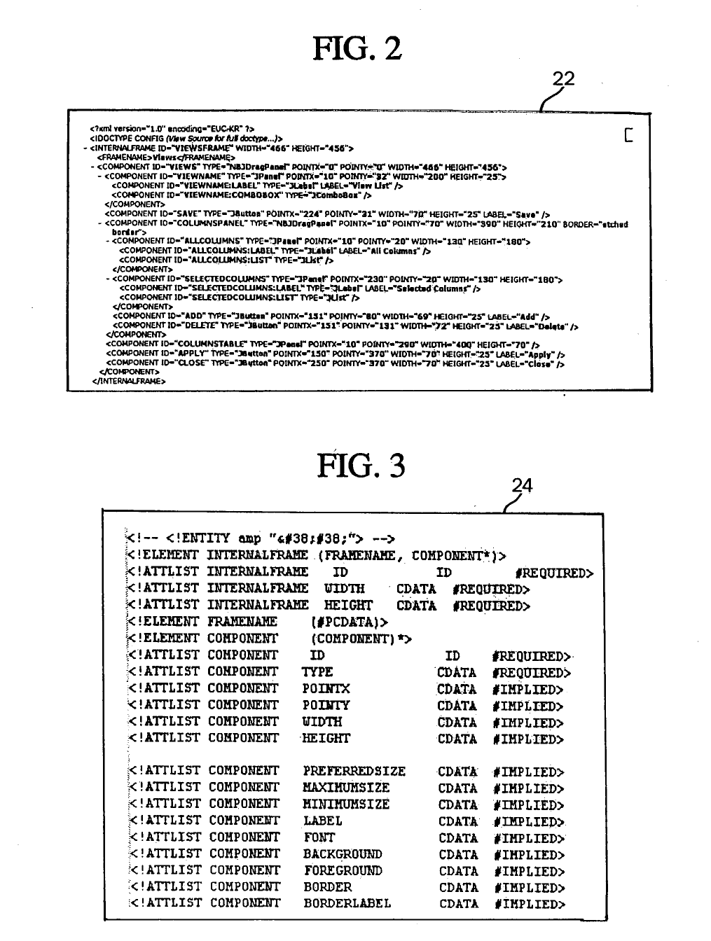

The file with the Extensible Markup Language (XML) extension manages property values of a component corresponding to each display window. FIG. 2 illustrates an example of contents of files with an Extensible Markup Language (XML) extension to store property information of a component, in accordance with the principles of the present invention.

The file with Document Type Definition (DTD) extension monitors whether the file with the Extensible Markup Language (XML) extension storing property information of a component is validated or not. In other words, a property information used in the file with the Extensible Markup Language (XML) extension is defined.

The file with an Extensible Markup Language (XML) extension stores a property parameter defined by a file with a Document Type Definition (DTD) extension, while the file with Document Type Definition (DTD) extension designates a kind of a component property corresponding to each display window.

The kind of a component property includes at least one of an identification, a type, an x-axis position, a y-axis position, a width, a height, an optimum size, a maximum size, a minimum size, a label, a font, a background, a foreground, an edge, a color.

FIG. 3 illustrates an example of contents of files with a Document Type Definition (DTD) extension to store property information of a component, in accordance with the principles of the present invention. Referring to FIG. 3, a component property defined by Document Type Definition (DTD) includes an identification ID, a type TYPE, an x-axis position POINTX, a y-axis position POINTY, a width WIDTH, a height HEIGHT, an optimized size PREFERREDSIZE, a maximum size MAXIMUMSIZE, a minimum size MINIMUMSIZE, a label LABEL, a font FONT, a background BACKGROUND, a foreground FOREGROUND, a border BORDER, and a border label BORDERLABEL.

In other words, referring to FIG. 3, property information of a component includes an identification ID, a type TYPE, an x-axis position POINTX, a y-axis position POINTY, a width WIDTH, a height HEIGHT, an optimized size PREFERREDSIZE, a maximum size MAXIMUMSIZE, a minimum size MINIMUMSIZE, a label LABEL, a font FONT, a background BACKGROUND, a foreground FOREGROUND, a border BORDER, and a border label BORDERLABEL.

At first, the NBJDragPanel uses the terminology inherited from JPanel, and the terminology will be defined in the following statements. NBJDragPanel, NBJGlassPane, and NXPropertyDialog are graphic user interfaces (GUIs) displayed on the user monitor. In other words, on the user monitor, the NBJDragPanel module 31 generates NBJDragPanel, the NBJGlassPane module 32 generates NBJGlassPane, and the NXPropertyDialog module 33 generates NXPropertyDialog. The XMLMsg module 34 is a software module associated with managing a file with an Extensible Markup Language (XML) extension, and manages configuration information of graphic user interface (GUI) components.

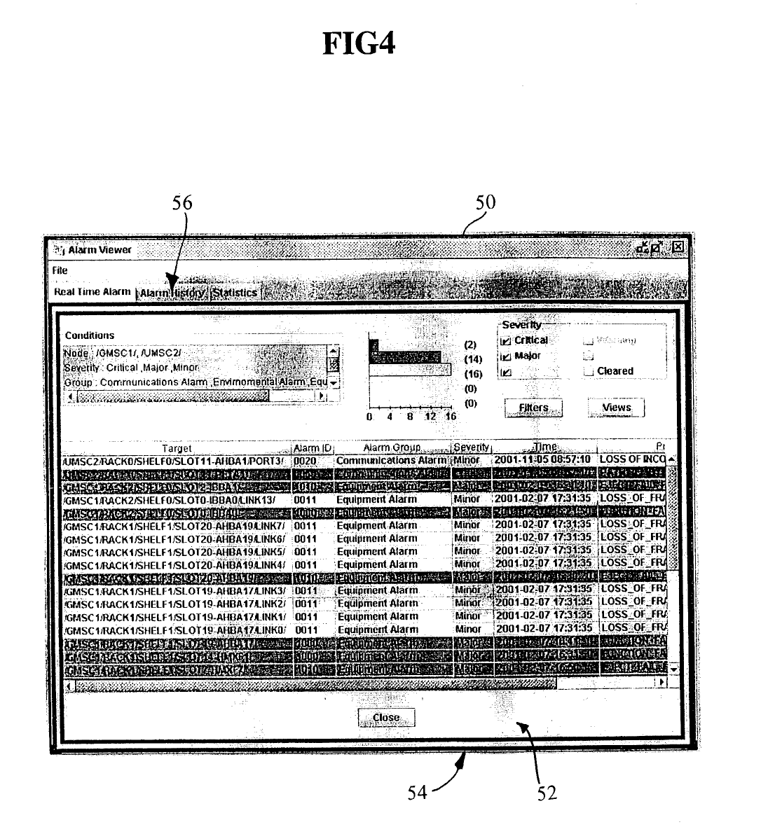

FIG. 4 is a display window generated by a module such as NBJDragPanel, in accordance with the principles of the present invention. The FIG. 4 shows image 50.

The NBJDragPanel module 31 searches configuration information of the graphic user interface (GUI) components of application programs by calling the XMLMsg module 34, and reflects the searched result in a display window in real time. Therefore, NBJDragPanel is generated and displayed on the user monitor as shown in FIG. 4. In FIG. 4, NBJDragPanel 52 is an example of an NBJDragPanel. NBJGlassPanel 54 is an example of an NBJGlassPanel. Additionally, the NBJDragPanel module 31 calls the NBJGlassPanel module 32 in a design mode.

The NBJGlassPane 54 can also be described as a glass pane 54, glass panel 54, border region 54 or border panel 54. The NBJGlassPane 54 is overlapped at the NBJDragPanel 52. The NBJDragPanel 52 can also be described as a main panel 52. Therefore, the border panel 54 can be said to be displayed as overlapping the main panel 52. The main panel 52 displays a plurality of components including at least the “alarm history” component 56 or “alarm history” tab 56.

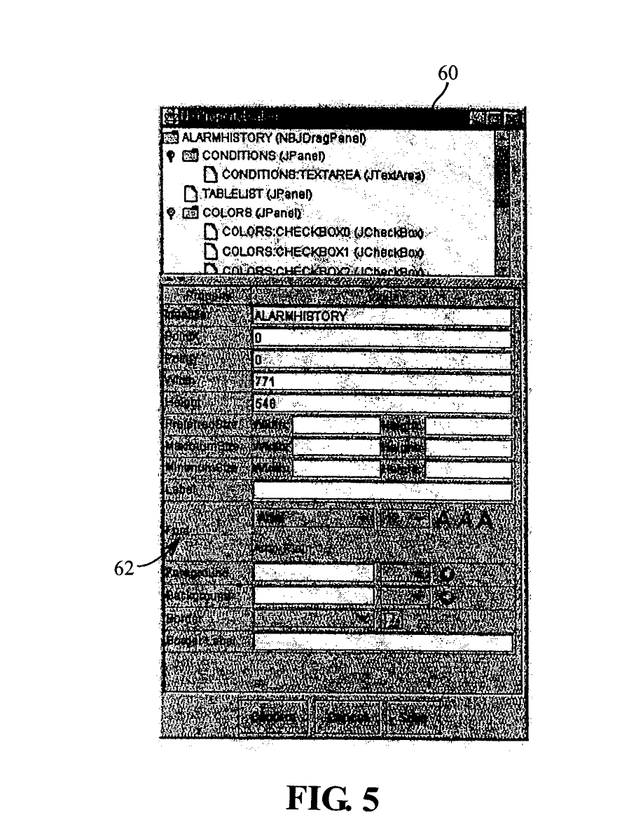

When a user selects the “alarm history” tab 56 shown in main panel 52 of FIG. 4 by selecting a coordinate corresponding to the tab 56 on the border panel 54, then the display window 60 of FIG. 5 is displayed on the monitor. The display window 60 shows property information including property values of the “alarm history” component 56. After the display window 60 is displayed on the monitor, the user can then modify the property values shown in display window 60. After the user modifies one or more property values shown in display window 60, then the changes are applied in the graphic user interface and the user has an opportunity to see the result of the changes to the graphic user interface and has an opportunity to confirm the changes or to cancel the changes. If the changes are confirmed by the user, then the new property information is stored in the first storing module 10 of FIG. 1.

The NBJGlassPane module 32 called by the NBJDragPanel module 31 generates a graphic user interface (GUI), NBJGlassPane 54, surrounding NBJDragPanel 52. NBJGlassPane 54 is a thick solid line surrounding NBJDragPane 52 in FIG. 4. When a user clicks a predetermined position of NBJGlassPanel 54 with a mouse input device, a graphic user interface (GUI) component corresponding to the click position is searched in the NBJDragPanel module 31 and transferred to the NXPropertyDialog module 33. A keyboard or track ball input device, or other input device, can be used instead of, or in addition to, the mouse input device.

The NXPropertyDialog module 33 called by the NBJGlassPane module 32 searches a property value of the graphic user interface (GUI) component in the XMLMsg module 34, and outputs the property value to a property display window of the NXPropertyDialog. After the property value inputted through the property display window is reflected to the graphic user interface (GUI) interface, the property information of the component in the first storage module 10 is revised through the XMLMsg module 34.

FIG. 5 illustrates a property window generated by a module such as NXPropertyDialog, in accordance with the principles of the present invention. FIG. 5 illustrates an example of a property display window 60 generated by the NXPropertyDialog module 33. The property display window 60 displays property information of a graphic user interface (GUI). The values of the property information can be modified with the use of a mouse and/or a keyboard, by entering in new values at one or more of the various fields displayed in the window 60. For example, a user can change current font data of a graphic user interface to new font data by inputting the new font data at the property window 60 in the appropriate fields, that is the font-related fields 62.

A computer mouse, computer keyboard, or other input device can be used to enter the new font data at the property window 60 in the font-related fields 62. The property window 60, also referred to as a display window 60, is displayed on a monitor so that a user can perceive the information. The monitor can be a cathode ray tube (CRT) display, a flat panel liquid crystal display (LCD), or any other monitor for displaying varying visual information to a user.

The XMLMsg module 34 manages configuration information of a graphic user interface (GUI) component stored in the first storage module 10. In other words, as configuration information of a graphic user interface (GUI) component is stored in a file with Extensible Markup Language (XML) extension at the first storage module 10, the configuration information of the graphic user interface (GUI) component is read from the corresponding file with Extensible Markup Language (XML) extension and registered in a memory. Additionally, property values of a predetermined graphic user interface (GUI) component are searched and transferred to the NBJDragPanel module 31 and the NXPropertyDialog module 33, and are changed according to the requests of the NXPropertyDialog module 33. By storing the configuration information of the temporary memory as a file with Extensible Markup Language (XML) extension, the changed configuration information is reflected to a display window of a user monitor even in the case of re-operating a software program.

When image 50 of FIG. 4 is displayed on a monitor, a user can then select a portion of the NBJGlassPane 54 that surrounds the NBJDragPanel 52. After the user selects a portion of the NBJGlassPane 54, then the window 60 of FIG. 5 is displayed in accordance with the selected portion of the NBJGlassPane 54. When the window 60 of FIG. 5 is displayed, the user can view property information and input changes to the property information at window 60 shown in FIG. 5. The changes are stored. The “confirm” button in window 60 allows a user an opportunity to confirm that the changes are indeed desired. The “cancel” and “save” buttons in window 60 function to cancel changes and save changes, respectively.

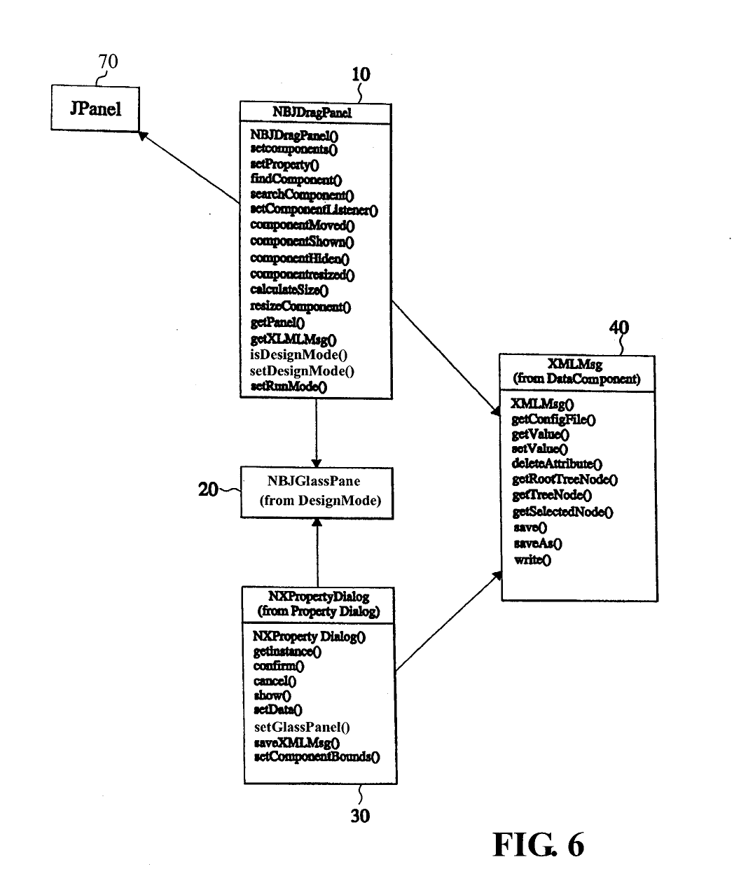

FIG. 6 is a conceptual diagram illustrating connection relations among each function block of FIG. 1, in accordance with the principles of the present invention. FIG. 6 is a conceptual diagram illustrating connection relations among each function block of FIG. 1, and shows a connection relation among each class such as Panel (10, 20, 70), Property Window (30), and an Extensible Markup Language (XML) File Handler (40). Functions of each module will be illustrated by referring drawings.

The NBJDragPanel module 31 calls and performs at least the following 17 functions: public NBJDragPanel( ); public void setComponents( ); private void setProperty( ); public Component findComponent( ); private Component searchComponent( ); public void setComponentListener( ); public void componentMoved( ); public void componentShown( ); public void componentHidden( ); public void component Resized( ); private void calculateSize( ); private void resizeComponent( ); public JPanel getPanel( ); public XMLMsg getXMLMsg( ); public Boolean isDesignMode( ); public void setDesignMode( ); and public void setRunMode( ).

The public NBJDragPanel( ) function creates NBJDragPanel class.

The public void setComponents( ) function calls setProperty( ) function, after reading configuration information through the XMLMsg module 34, and displaying the configuration information to a display window.

The private void setProperty ( ) function searches configuration information of the graphic user interface (GUI) component included in NBJDragPanel through the XMLMsg module 34, and displays the configuration information to a display window.

The public Component findComponent( ) function calls searchComponent ( ) searching a predetermined graphic user interface (GUI) component included in NBJDragPanel.

The private Component searchComponent ( ) function searches a predetermined graphic user interface (GUI) component.

The public void setComponentListener ( ) function generates an event when a display window of NBJDragPanel is changed.

The public void componentMoved ( ) function does not perform any function while receiving an event when a display window of NBJDragPanel is moved.

The public void componentShown ( ) does not perform any function while receiving an event when a display window of NBJDragPanel is shown.

The public void componentHidden ( ) function does not perform any function while receiving an event when a display window of NBJDragPanel is hidden.

The public void component Resized ( ) function calls calculateSize ( ) to change size of the graphic user interface (GUI) component included in NBJDragPanel after receiving an event, when a size of a display window of NBJDragPanel is changed.

The private void calculateSize ( ) function calls resizeComponent ( ) after getting a change ratio between the previous display window and the changed display window, when a size of a display window in NBJDragPanel is changed.

The private void resizeComponent ( ) function applies a size change ratio from calculateSize ( ) to the graphic user interface (GUI) component included in NBJDragPanel.

The public JPanel getPanel ( ) function gets NBJDragPanel.

The public XMLMsg getXMLMsg ( ) function gets XMLMsg in NBJDragPanel.

The public Boolean isDesignMode ( ) function searches whether NBJDragPanel designs the present display window or performs a function.

The public void setDesignMode ( ) function makes NBJDragPanel design a display window, and generate NBJGlassPane to overlaps NBJDragPanel.

The public void setRunMode ( ) function makes NBJDragPanel perform a display window, and eliminate NBJGlassPane from NBDragPanel.

The NBJGlassPane module 32 called by the NBJDragPanel module 31 generates NBJGlassPane surrounding NBJDragPanel. Therefore, when a user clicks a position of NBJGlassPane with a mouse, the NBJGlassPane module 32 searches a graphic user interface (GUI) component corresponding to the clicked position in the NBJDragPanel module 31, and transmits the graphic user interface (GUI) component to the NXPropertyDialog module 33.

The NXPropertyDialog module 33 calls and performs at least the following nine functions: private NXPropertyDialog( ); public static synchronized NXPropertyDialog getInstance( ); public void confirms( ); public void cancels( ); public void show( ); public void setData(XMLMsg pXMLMsg); public void setGlassPanel( ); public void saveXMLMsg( ); and set ComponentBounds( ).

The private NXPropertyDialog ( ) function generates NXPropertyDialog class.

The public static synchronized NXPropertyDialog getInstance( ) function can be managed by one NXPropertyDialog, and calls NXPropertyDialog ( ).

The public void confirm ( ) function stores the inputted property value through the XMLMsg module 34, modify a property value of the graphic user interface (GUI) component selected from NBJDragPanel, and reflect the property value to a display window.

The public void cancel ( ) function eliminates NBJGlassPane from NBJDragPanel.

The public void show ( ) function searches a property value of the graphic user interface (GUI) component selected from NBJDragPanel through the XMLMsg module 34, and outputs the property value to a display window.

The public void setData (XMLMsg pXMLMsg) function reflects a property value stored in the first storage module 10 through the XMLMsg module 34 to a display window of NXPropertyDialog.

The public void setGlassPanel ( ) function sets setGlassPanel.

The public void saveXMLMsg ( ) function stores information of XSMLMsg module 34 as a type of electronic file.

The public void setComponentBounds( ) function stores size and position information of a predetermined graphic user interface (GUI) component to a memory of the XMLMsg module 34, and reflects the size and the position information to a display window of NXPropertyDialog.

The XMLMsg module 34 calls and performs at least the following eleven functions: public XMLMsg( ); public String getConfigFile( ); public String getValue( ); public void setValue( ); public void deleteAttribute( ); public DefaultMutableTreeNode getRootTreeNode( ); public DefaultMutableTreeNode getTreeNode( ); public DefaultMutableTreeNode getSelectedNode( ); public void save( ); public void saveAs( ); and public void write( ).

The public XMLMsg ( ) function generates a class of the XMLMsg module 34, reads a file with an Extensible Markup Language (XML) extension storing property information through the function of getConfigFile ( ), and stores the contents of the file with an Extensible Markup Language (XML) extension to a temporary memory.

The public String getConfigFile ( ) function selects a predetermined file among files from the first storage module 10 storing property information.

The public String getValue ( ) function searches a property value of the graphic user interface (GUI) component.

The public void setValue ( ) function modifies a property value of the graphic user interface (GUI) component.

The public void deleteAttribute ( ) function deletes a property value of the graphic user interface (GUI) component.

The public DefaultMutableTreeNode getRootTreeNode ( ) function converts configuration information stored in a temporary memory to a tree node. The tree node information is used by the NXPropertyDialog module 33 and reflected to a display window.

The public DefaultMutableTreeNode getTreeNode ( ) function is called by getRootTreeNode ( ) to generate subordinate information as a tree node.

The public DefaultMutableTreeNode getSelectedNode ( ) function generates subordinate information of the selected graphic user interface (GUI) component as a tree node.

The public void save ( ) function calls write ( ) to information from the memory to a file.

The public void saveAs ( ) function stores information from the. memory to another file.

The public void write ( ) function parses information from the memory, and records the information into a file.

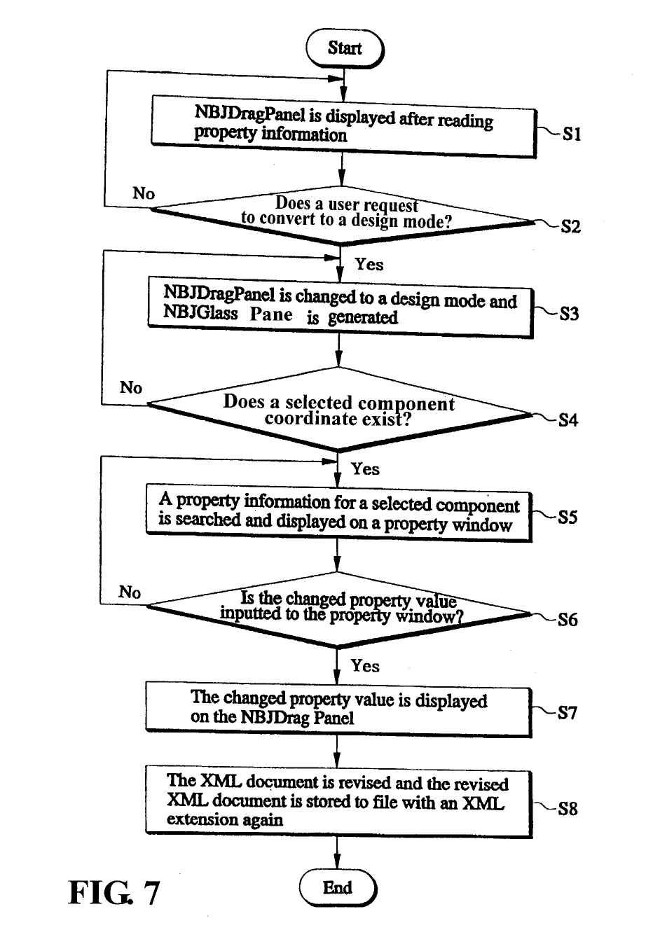

FIG. 7 is a flow chart performing the graphic user interface (GUI) modification among each function block of FIG. 1, in accordance with the principles of the present invention. At step S1, after reading property information, a main panel is displayed on a user monitor. Basically, the main panel in each display window inherits NBJDragPanel. NBJDragPanel can manage a property window.

At step S2, through menus, it is decided whether a user requests to convert to a design mode or not. At step S3, when there is a request to convert to a design mode, NBJDragPanel is changed to a design mode, and NBJGlassPane is generated to overlap the main panel. NBJGlassPane controls a mouse event generated afterwards.

At step S4, when a coordinate is selected for a component in NBJGlassPane, it is decided whether a selected component coordinate exists or not. When the user selects a predetermined component by use of a mouse input device, NBJGlassPane searches a corresponding component in the main panel by using the coordinate designated by the mouse, and transmits the selected component information to the NXPropertyDialog module 33.

At step S5, the NXPropertyDialog module 33 sequentially performs the following actions: the NXPropertyDialog module 33 reads a file with an Extensible Markup Language (XML) extension to generate an Extensible Markup Language (XML) document; the NXPropertyDialog module 33 searches property information by using an identification ID of the selected component; the NXPropertyDialog module 33 reads each property value from the corresponding Extensible Markup Language (XML) document; and the NXPropertyDialog module 33 outputs the property value to a property window.

At step S6, a determination is made to decide whether the changed property value is inputted to the property window. At step S7, when the changed property value is inputted, the changed property value is displayed on the NBJDragPanel, and property information of the corresponding component is updated according to the changed property value.

At step S8, the Extensible Markup Language (XML) document is revised and the revised Extensible Markup Language (XML) document is stored to a file with an Extensible Markup Language (XML) extension again.

According to the above description for the present invention, by not only isolating NBJDrag Pane function from XMLMsg configuration, but also adding NXPropertyDialog, property value is changed, reflected to a display window, and stored in a file in real time, and the changed property value is applied when a software program is re-operated. Therefore, it can be avoided to modify a source code to change a property value, because NBJDragPanel coexists with XMLMsg corresponding to property information of the graphic user interface (GUI) component.

Additionally, a component property can be revised in real time. Therefore, maintenance for a software program is easy, after completing development of the software program. In more, a window layout can be changed easily according to the request of a system developer or a user.

Additional compiling of the software program is not necessary to revise the property, and a display function is separated from a display user interface (UI) to enable a structural display design.

In an embodiment of the present invention, the above-described steps of the present invention can be instructions stored in a memory, and the instructions stored in the memory can be performed by one or more computers. The memory could be any kind of computer readable medium such as floppy disks, conventional hard disks, removable hard disks, compact discs (CDs), digital versatile discs (DVDs), flash read only memory (flash ROM), nonvolatile read only memory, and random access memory (RAM), for example. The monitor displaying the window 50 and the window 60 is a monitor connected to a computer system such as a personal computer (PC), a desktop computer, a workstation, a server, a portable computer, a notebook computer, a hand-held computer, a palm-sized computer, a wearable computer, or any other type of computer system. The computer system connected to the monitor includes a hard disk drive and other kinds of computer readable media.

In an embodiment of the present invention, at least one of the above-described steps of the present invention can correspond to an execution of instructions stored in one or more memory units. For example, one of these memory units could include the first storing module 10 and the second storing module 20 installed in the computer system. Instructions stored in such a memory unit can be executed or performed by one or more computers.

A software implementation of the above-described embodiment may comprise a series of computer instructions either fixed on a tangible medium, such as computer readable media, for example a compact disc or a fixed disk, or transmissible to a computer system via a modem or other interface device over a medium. The medium can be either a tangible medium, including, but not limited to, optical or analog communications lines, or may be implemented with wireless techniques, including but not limited to microwave, infrared or other transmission techniques. The medium may also be the Internet. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, for example, shrink wrapped software, pre-loaded with a computer system, for example, on system read only memory (ROM) or fixed disk, or distributed from a server or electronic bulletin board over a network, for example, the Internet or World Wide Web.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. A graphic user interface (GUI) modification method for changing the graphic user interface of an application program, the method comprising:
storing property information of a plurality of components of a graphic user interface, the plurality of components including at least a first component;
storing data of a software program displaying the graphic user interface on a monitor in dependence upon the stored property information of the components;
displaying at least a portion of the stored property information of the first component to a display window on the monitor;
when receiving changed property information at the display window, updating the stored property information of the first component in dependence upon the changed property information; and
when the stored property information is updated, operating the software program to display changed graphic user interface in dependence upon the changed property information.

2. The method of claim 1, said storing of the property information corresponding to storing the property information in a file with an Extensible Markup Language extension.

3. The method of claim 1, said storing of the property information corresponding to storing the property information in a file with an Extensible Markup Language extension, the file with the Extensible Markup Language extension including a property parameter defined by a file with a Document Type Definition extension, the file with Document Type Definition extension designating a kind of a component property.

4. The method of claim 3, the kind of the component property including at least one selected from among an identification, a type, an x-axis position, a y-axis position, a width, a height, an optimum size, a maximum size, a minimum size, a label, a font, a background, a foreground, an edge, and a color.

5. The method of claim 1, said updating of the stored property information further comprising:
interrupting an input event at a main panel of the graphic user interface displayed to a main window on the monitor, the main window being distinguishable from the display window;
overlapping a border panel onto the main panel, the border panel being for selecting a component from among the plurality of components displayed by the main panel;
when a coordinate is selected on the border panel and the selected coordinate corresponds to the first component, displaying the stored property information of the first component to the display window;
when receiving the changed property information at the display window, displaying the main panel of the graphic user interface in dependence upon the changed property information; and
when the displayed main panel corresponding to the changed property information is confirmed, updating and re-storing the changed property information.

6. The method of claim 5, said storing of the property information corresponding to storing the property information in a file with an Extensible Markup Language extension, the file with the Extensible Markup Language extension including a property parameter defined by a file with a Document Type Definition extension, the file with Document Type Definition extension designating a kind of a component property.

7. The method of claim 6, the kind of the component property including at least one selected from among an identification, a type, an x-axis position, a y-axis position, a width, a height, an optimum size, a maximum size, a minimum size, a label, a font, a background, a foreground, an edge, and a color.

8. The method of claim 7, said storing of the data for the software program to display the graphic user interface on the monitor being performed in real time.

9. The method of claim 8, the data of the software program being stored separately from the property information of the plurality of components.

10. A recorded media for recording a software program operating and changing a graphic user interface (GUI) of an application program, comprising:
a first storage module storing property information of a plurality of components of a graphic user interface, the plurality of components including at least a first component;
a second storage module storing data of a software program displaying the graphic user interface to a monitor by reading the stored property information from said first storage module; and
a graphic user interface management module displaying at least a portion of the property information stored in said first storage module to a display window, updating the property information stored in said first storage module by receiving changed property information at the display window, and displaying a changed graphic user interface in dependence upon the received changed property information.

11. The media of claim 10, said graphic user interface management module comprising:
a first function module operating the software program in dependence upon the data stored in said second storage module, and displaying a main panel of the graphic user interface to a main window by reading the property information stored in said first storage module, the main panel displaying the plurality of components;
a second function module interrupting an input event to the main panel of the graphic user interface displayed in the main window, and overlapping a border panel onto the main panel, the border panel being for selecting a component from among the plurality of components displayed at the main panel;
a third function module displaying the stored property information of the first component to the display window when a coordinate is selected on the border panel and the selected coordinate corresponds to the first component, and receiving the changed property information at the display window; and
a fourth function module updating and re-storing property information at said first storage module in dependence upon the changed property information received by said third function module when the changed property information is inputted at the display window displayed by the third function module, and displaying the main panel of the graphic user interface in dependence upon the changed property information.

12. The media of claim 11, said first storage module storing the property information in a file with an Extensible Markup Language extension.

13. The media of claim 11, said first storage module storing the property information in a file with an Extensible Markup Language extension, the file with the Extensible Markup Language extension including a property parameter defined by a file with a Document Type Definition extension, the file with Document Type Definition extension designating a kind of a component property.

14. The media of claim 13, the kind of the component property including at least one selected from among an identification, a type, an x-axis position, a y-axis position, a width, a height, an optimum size, a maximum size, a minimum size, a label, a font, a background, a foreground, an edge, and a color.

15. The media of claim 14, said second storage module storing the data of the software program displaying the graphic user interface to the monitor in real time by reading the stored property information from said first storage module in real time.

16. The media of claim 15, said first storage module being distinguishable from said second storage module.

17. The media of claim 16, said graphic user interface management module performing the displaying of the property information, performing the updating of the property information, and performing the displaying of the changed graphic user interface in response to requests.
